(19) United States
(12) Patent Application Publication
(10) Pub. No.: US 2015/0253628 A1
(43) Pub. Date: Sep. 10, 2015

(54) LIQUID CRYSTAL DISPLAY DEVICE, METHOD OF MANUFACTURING THE SAME, AND ALIGNMENT LAYER COMPOSITION

(71) Applicant: Samsung Display Co., Ltd., Yongin-City (KR)

(72) Inventors: Sang Gyun KIM, Hwaseong-si (KR); Tae Jin KONG, Bucheon-si (KR); Taek Joon LEE, Hwaseong-si (KR)

(21) Appl. No.: 14/479,802

(22) Filed: Sep. 8, 2014

(30) Foreign Application Priority Data
Mar. 7, 2014 (KR) 10-2014-0027213

(51) Int. Cl. G02F 1/1337; C09K 19/56; C08G 73/10; B05D 3/00

(52) U.S. Cl. CPC G02F 1/133711; B05D 3/007; C09K 19/56; C08G 73/10

(57) ABSTRACT

A liquid crystal display includes: a lower substrate; an upper substrate facing the lower substrate; an alignment layer on the lower substrate and the upper substrate; and a liquid crystal layer between the lower substrate and the upper substrate. The alignment layer includes two monomers including polyimide and a reactive mesogen, and an alignment solvent. The alignment solvent includes a first solvent configured to increase solubility of a polymer, a second solvent configured to increase spreadability of the alignment solvent, and a third solvent configured to decrease vapor pressure of the alignment solvent. A total content of the first solvent and the second solvent is from about 70 weight percent to about 95 weight percent based on a total weight of the alignment solvent. The alignment solvent has the vapor pressure at 90° C. from about 10 mm Hg to about 20 mm Hg.

This application claims priority to Korean Patent Application No. 10-2014-0027213 filed on Mar. 7, 2014, and all the benefits accruing therefrom under 35 U.S.C. §119, the entire contents of which are incorporated herein by reference.

### BACKGROUND

(a) Field

The invention relates to a liquid crystal display, a manufacturing method thereof, and an alignment layer composition included therein.

(b) Description of the Related Art

A liquid crystal display, which is one of the most common types of flat panel displays used, includes two sheets of display panels with field generating electrodes such as a pixel electrode, a common electrode, and the like, and a liquid crystal layer interposed between the display panels. The liquid crystal display generates an electric field in the liquid crystal layer by applying voltages to the field generating electrodes, and determines the direction of liquid crystal molecules of the liquid crystal layer by the generated electric field, thus controlling polarization of incident light so as to display images.

Among the liquid crystal displays, a vertically aligned mode liquid crystal display, in which liquid crystal molecules are aligned so that long axes thereof are perpendicular to the upper and lower panels while the electric field is not applied, has been in the limelight because a contrast ratio is large and a wide reference viewing angle is easily implemented.

In such a vertically aligned mode liquid crystal display, in order to implement a wide viewing angle, a plurality of domains having different alignment directions of the liquid crystal may be formed in one pixel. As a means of forming the plurality of domains, a method of defining cutouts such as minute slits in the field generating electrode or disposing protrusions on the field generating electrode is used. According to the method, the plurality of domains may be formed by aligning the liquid crystal in a direction perpendicular to the fringe field by edges of the cutouts or the protrusions and a fringe field formed between the field generating electrodes facing the edges.

The liquid crystal display in the vertically aligned mode may have degraded side visibility compared to front visibility. To solve the problem, a method of dividing the one pixel into two subpixels and making voltages of the two subpixels different has been proposed.

In order to make a response speed of the liquid crystal relatively fast while implementing the wide viewing angle, a method of allowing a liquid crystal to have a pretilt in a state in which the electric field is not applied has been developed. To allow the liquid crystals to have the pretilts in several directions, an alignment layer having several alignment directions is used, or a reactive mesogen is added to the alignment layer or the liquid crystal layer and then light is irradiated to the alignment layer or the liquid crystal layer in the state in which the electric field is applied thereto, thereby forming the pretilt.

### SUM MARY

One or more exemplary embodiment of the invention provides an aligning agent composition configured to define a uniform pretilt when pretilting a liquid crystal molecule without a dry stain when forming an alignment layer, by controlling a vapor pressure and a surface tension of an alignment solvent included in the aligning agent composition in an appropriate range, a liquid crystal display applied with the alignment layer, and a manufacturing method of the liquid crystal display.

A liquid crystal display according to an exemplary embodiment of the invention includes: a lower substrate; an upper substrate facing the lower substrate; an alignment layer on the lower substrate and the upper substrate; and a liquid crystal layer between the lower substrate and the upper substrate. The alignment layer includes two monomers including polyimide and a reactive mesogen, and an alignment solvent. The alignment solvent includes a first solvent configured to increase solubility of a polymer, a second solvent configured to increase spreadability of the alignment solvent, and a third solvent configured to decrease vapor pressure of the alignment solvent. A total content of the first solvent and the second solvent is from about 70 weight percent to about 95 weight percent based on a total weight of the alignment solvent. The alignment solvent has the vapor pressure at 90° C. from about 10 mm Hg to about 20 mm Hg.

The surface tension of the alignment solvent at 23° C. may be from about 38 dyn/cm to about 45 dyn/cm, and the vapor pressure of the alignment solvent at 20° C. may be from about 0.25 mm Hg to about 0.4 mm Hg.

The alignment solvent may additionally include a fourth solvent as an additive.

The first solvent may be N-methyl pyrrolidone (“NMP”), the second solvent may be butyl carbitol (“BC”), the third solvent may be propylene carbonate (“PC”), and the fourth solvent may be 3-methoxy-N,N-dimethylpropionamide.

Based on the total weight of the alignment solvent, the N-methyl pyrrolidone may be from about 45 weight percent to about 55 weight percent, the butyl carbitol may be from about 30 weight percent to about 40 weight percent, the propylene carbonate may be from about 20 weight percent to about 40 weight percent, and the 3-methoxy-N,N-dimethylpropionamide may be from about 8 weight percent to about 12 weight percent.

The alignment solvent may additionally include y-butyrolactone, diethylene glycol diethyl ether, or both.

A drying stain may be absent from the alignment layer.

A manufacturing method of a liquid crystal display according to an exemplary embodiment of the invention includes: coating an aligning agent composition on a substrate; and drying the coated aligning agent composition at a drying temperature from about 80° C. to about 120° C. The aligning agent composition includes two monomers including polyimide and a reactive monomer, and an alignment solvent. The alignment solvent includes a first solvent configured to increase solubility of a polymer, a second solvent configured to increase spreadability of the alignment solvent, and a third solvent configured to decrease vapor pressure of the alignment solvent. A total content of the first solvent and the second solvent is from about 70 weight percent to about 95 weight percent based on a total weight of the alignment solvent. The vapor pressure of the alignment solvent is from about 10 mm Hg to about 20 mm Hg at the drying temperature.

The alignment solvent may additionally include a fourth solvent as an additive.

The first solvent may be N-methyl pyrrolidone (“NMP”), the second solvent may be butyl carbitol (“BC”), the third solvent may be propylene carbonate (“PC”), and the fourth solvent may be 3-methoxy-N,N-dimethylpropionamide.

Based on the total weight of the alignment solvent, the N-methyl pyrrolidone may be from about 45 weight percent to about 55 weight percent, the butyl carbitol may be from about 30 weight percent to about 40 weight percent, the propylene carbonate may be from about 20 weight percent to about 40 weight percent, and the 3-methoxy-N,N-dimethylpropionamide may be from about 8 weight percent to about 12 weight percent.

The drying the aligning agent composition may generate a uniform phase separation of the two monomers.

The drying the aligning agent composition may not generate a stain in the dried alignment layer.

A aligning agent composition according to an exemplary embodiment of the invention includes two monomers including polyimide and a reactive monomer, and an alignment solvent. The alignment solvent includes a first solvent configured to increase solubility of a polymer, a second solvent configured to increase spreadability of the alignment solvent, and a third solvent configured to decrease vapor pressure of the alignment solvent. A total content of the first solvent and the second solvent is from about 70 weight percent to about 95 weight percent based on a total weight of the alignment solvent. The alignment solvent has the vapor pressure at 90° C. from about 10 mm Hg to about 20 mm Hg.

The surface tension of the alignment solvent at 23° C. may be from about 38 dyn/cm to about 45 dyn/cm, and the vapor pressure at 20° C. may be from about 0.25 mm Hg to about 0.4 mm Hg.

The alignment solvent may additionally include a fourth solvent as an additive.

The first solvent may be N-methyl pyrrolidone (“NMP”), the second solvent may be butyl carbitol (“BC”), the third solvent may be propylene carbonate (“PC”), and the fourth solvent may be 3-methoxy-N,N-dimethylpropionamide.

Based on the total weight of the alignment solvent, the N-methyl pyrrolidone may be from about 45 weight percent to about 55 weight percent, the butyl carbitol may be from about 30 weight percent to about 40 weight percent, the propylene carbonate may be from about 20 weight percent to about 40 weight percent, and the 3-methoxy-N,N-dimethylpropionamide may be from about 8 weight percent to about 12 weight percent.

The alignment solvent may additionally include y-butyrolactone, diethylene glycol diethyl ether, or both.

As described above, one or more exemplary embodiment of the aligning agent composition according to the invention and the liquid crystal display including the alignment layer manufactured by using the aligning agent controls the vapor pressure and the surface tension of the alignment solvent included in the aligning agent composition with the appropriate range such that the drying stain of the alignment layer may be reduced or effectively prevented. Also, since the functional polymer is uniformly distributed by the relatively slow drying of the aligning agent in the alignment layer, when forming the pretilt of the liquid crystal molecule, the uniform pretilt is formed on the entire region and the stain due to the difference of the pretilt angle is reduced or effectively prevented.

### BRIEF DESCRIPTION OF THE DRAWINGS

The above and other features of this disclosure will become more apparent by describing in further detail exemplary embodiments thereof with reference to the accompanying drawings in which:

FIG. 1 is a plan view of an exemplary embodiment of a pixel of a liquid crystal display according to the invention.

FIG. 2 is a cross-sectional view of the liquid crystal display of FIG. 1 taken along line II-II.

FIG. 3 is a top plan view of an exemplary embodiment of a base region of a pixel electrode of a liquid crystal display according to the invention.

FIG. 4 is a graph of vapor pressure and surface tension of an alignment solvent of an exemplary embodiment of the invention and a comparative example.

FIG. 5 includes views of images of formed films after coating and drying an aligning agent composition according to Exemplary Embodiments of the invention and a Comparative Example, on a glass substrate.

FIG. 6 includes views showing results of evaluating a surface via scanning electron microscope (“SEM”) for positions of a manufactured alignment layer of a liquid crystal display by using an aligning agent composition of Exemplary Embodiment 1 and Comparative Example 1.

FIG. 7 is a diagram illustrating an exemplary embodiment of a process of allowing liquid crystal molecules to have a pretilt by using an alignment layer including a light reaction group, such as with ultraviolet rays.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Now, an exemplary embodiment of a liquid crystal display according to the invention will be described with reference to accompanying drawings.

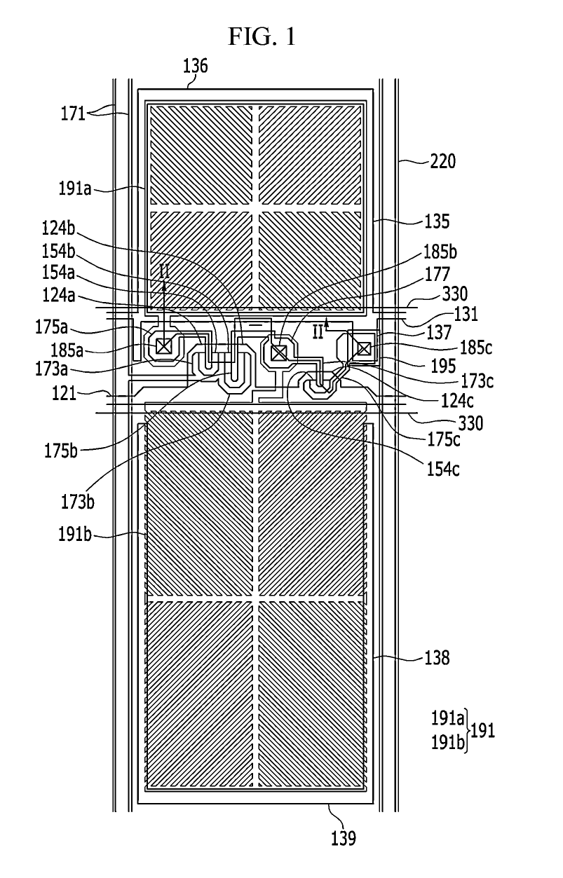

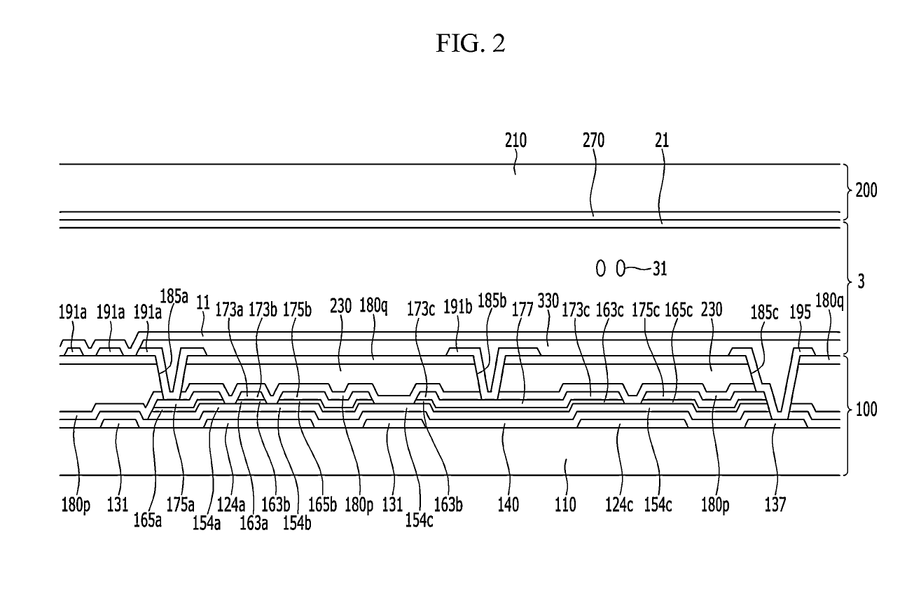

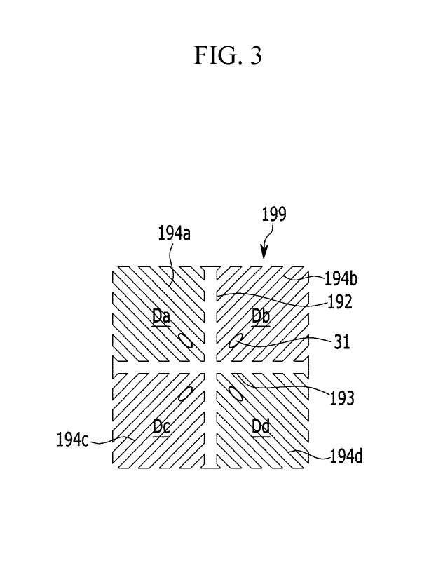

A structure of a liquid crystal display according to the invention will be described with reference to FIG. 1 to FIG. 3. FIG. 1 is a plan view of an exemplary embodiment of a pixel of a liquid crystal display according to the invention, and FIG. 2 is a cross-sectional view of the liquid crystal display of FIG. 1 taken along line II-II. FIG. 3 is a top plan view of an exemplary embodiment of a base region of a pixel electrode of a liquid crystal display according to the invention.

First, referring to FIG. 1 and FIG. 2, a liquid crystal display includes a lower (display) panel 100 and an upper (display) panel 200 facing each other, a liquid crystal layer 3 interposed between the two display panels 100 and 200, and a pair of polarizers (not shown) attached at the outer surfaces of the display panels 100 and 200.

First, the lower panel 100 will be described.

A gate conductor including a gate line 121 and a voltage division reference voltage line 131 are disposed on an insulating substrate 110 including transparent glass, plastics, or the like.

The gate line 121 includes a first gate electrode 124a, a second gate electrode 124b, a third gate electrode 124c and a wide end portion (not illustrated) for connection to another layer or an external driving circuit, each extended from a main portion thereof.

The voltage division reference voltage line 131 includes first storage electrodes 135 and 136, and a reference electrode 137, each extended from a main portion thereof. Second storage electrodes 138 and 139, which are not connected to the voltage division reference voltage line 131 but overlap a second subpixel electrode 191b, are positioned on the lower panel 100.

A gate insulating layer 140 is disposed on the gate line 121 and the voltage division reference voltage line 131.

A first semiconductor 154a, a second semiconductor 154b and a third semiconductor 154c are disposed on the gate insulating layer 140.

A plurality of ohmic contacts 163a, 165a, 163b, 165b, 163c and 165c are disposed on the semiconductors 154a, 154b and 154c.

A data conductor including a plurality of data lines 171 including a first source electrode 173a a second source electrode 173b extended from a main portion thereof, a first drain electrode 175a, a second drain electrode 175b, a third source electrode 173c and a third drain electrode 175c are disposed on the ohmic contacts 163a, 165a, 163b, 165b, 163c and 165c and the gate insulating layer 140.

In an exemplary embodiment of manufacturing the display device, the data conductors, and the semiconductors, and the ohmic contacts positioned under the data conductors, may be simultaneously formed by using one mask.

The data line 171 includes a wide end portion (not illustrated) for connection with another layer or an external driving circuit.

The first gate electrode 124a, the first source electrode 173a and the first drain electrode 175a form a first thin film transistor Qa together with the first semiconductor 154a, and a channel of the thin film transistor Qa is formed at an exposed portion of the semiconductor 154a between the first source electrode 173a and the first drain electrode 175a. Similarly, the second gate electrode 124b, the second source electrode 173b and the second drain electrode 175b form a second thin film transistor Qb together with the second semiconductor 154b, and a channel of the thin film transistor Qb is formed at a exposed portion of the semiconductor 154b between the second source electrode 173b and the second drain electrode 175b. The third gate electrode 124c, the third source electrode 173c and the third drain electrode 175c form a third thin film transistor Qc together with the third semiconductor 154c, and a channel of the thin film transistor Qc is formed at an exposed portion of the semiconductor 154c between the third source electrode 173c and the third drain electrode 175c.

The second drain electrode 175b is continuous with and connected with the third source electrode 173c, and includes an extended portion 177 that has a planar width larger than a remaining portion thereof.

A first passivation layer 180p is disposed on the data conductors 171, 173c, 175a, 175b, and 175c and exposed portions of the semiconductors 154a, 154b and 154c. The first passivation layer 180p may include an inorganic insulating layer, such as a silicon nitride or a silicon oxide. The first passivation layer 180p may reduce or effectively prevent pigment of a color filter 230 from flowing into the exposed portions of the semiconductors 154a, 154b and 154c. The color filter 230 is disposed on the first passivation layer 180p. The color filter 230 is extended in a vertical direction in the plan view, along two adjacent data lines 171. A first light blocking member 220 is positioned on the first passivation layer 180p, an edge of the color filter 230 and the data line 171.

The first light blocking member 220 is extended parallel to the data line 171, and is positioned between the two adjacent color filters 230. A width of the first light blocking member 220 taken perpendicular to an extension direction thereof, may be larger than that of the data line 171. As described above, the width of the first light blocking member 220 is larger than the width of the data line 171, so that the first light blocking member 220 may reduce of effectively prevent light incident from outside the liquid crystal display from being reflected from a surface of the metal material data line 171. That is, the light reflected from the surface of the data line 171 interferes with light passing through the liquid crystal layer 3, thereby preventing a contrast ratio of the liquid crystal display from being decreased.

A second passivation layer 180q is disposed on the color filter 230 and first light blocking member 220.

The second passivation layer 180q may include an inorganic insulating layer, such as a silicon nitride or a silicon oxide. The second passivation layer 180q reduces or effectively prevents the color filter 230 from being peeled or separated from other layers. The second passivation layer 180q also suppresses contamination of the liquid crystal layer 3 by an organic material such as a solvent flowing in from the color filter 230, thereby reducing or effectively preventing defects such as an afterimage that may occur when a display screen of the liquid crystal display is driven.

A first contact hole 185a and a second contact hole 185b exposing the first drain electrode 175a and the second drain electrode 175b are defined in the first passivation layer 180p and the second passivation layer 180q, respectively.

A third contact hole 185c exposing a part of the reference electrode 137 and a part of the third drain electrode 175c is defined in the first passivation layer 180p, the second passivation layer 180q and the gate insulating layer 140, and the third contact hole 185c is covered by a connecting member 195. The connecting member 195 electrically connects the reference electrode 137 and the third drain electrode 175c exposed through the third contact hole 185c to each other.

A plurality of pixel electrodes 191 is disposed on the second passivation layer 180q. Each pixel electrode 191 includes a first subpixel electrode 191a and a second subpixel electrode 191b which are separated from each other with the gate line 121 interposed therebetween and adjacent in a column (e.g., vertical) direction with respect to the gate line 121. The pixel electrode 191 may include a transparent material such as indium tin oxide (“ITO”) or indium zinc oxide (“IZO”). The pixel electrode 191 may include a transparent conductive material such as ITO or IZO, or a reflective metal such as aluminum, silver, chromium or an alloy thereof.

Each of the first subpixel electrode 191a and the second subpixel electrode 191b includes one or more basic electrode illustrated in FIG. 3, or a modification of the basic electrode.

The first subpixel electrode 191a and the second subpixel electrode 191b are physically and electrically connected to the first drain electrode 175a and the second drain electrode 175b through the first contact hole 185a and the second contact hole 185b, respectively, and receive the data voltage from the first drain electrode 175a and the second drain electrode 175b, respectively. A part of the data voltage applied to the second drain electrode 175b is divided through the third source electrode 173c, so that a size of the voltage applied to the first subpixel electrode 191a may be larger than that of the voltage applied to the second subpixel electrode 192b.

The first subpixel electrode 191a and the second subpixel electrode 191b to which the data voltage is applied generate an electric field in conjunction with a common electrode 270 of the upper panel 200 to determine a direction of liquid crystal molecules 31 of the liquid crystal layer 3 between the two electrodes 191 and 270. The luminance of light passing through the liquid crystal layer 3 is changed according to the thusly determined direction of the liquid crystal molecules 31.

A second light blocking member 330 is positioned on the pixel electrode 191. The second light blocking member 330 is disposed to cover all of the regions in which the first transistor Qa, the second transistor Qb the third transistor Qc, and the first to third contact holes 185a, 185b and 185c are positioned. The second light blocking member 330 is positioned to be extended in the same direction as that of the gate line 121 (e.g., horizontal or row direction in the plan view) to overlap a part of the data line 171. The second light blocking member 330 may be positioned so as to overlap a portion of the two data lines 171 which are positioned at opposing sides of a region of one pixel, to reduce or effectively prevent light leakage generated at the vicinity of the data line 171 and the gate line 121, and reduce or effectively prevent light leakage at the region in which the first transistor Qa, the second transistor Qb and the third transistor Qc are positioned.

In an exemplary embodiment of manufacturing a display device, before the second light blocking member 330 is formed, the first passivation layer 180p, the color filter 230 and the second passivation layer 180q are positioned within the regions in which the first transistor Qa, the second transistor Qb the third transistor Qc, and the first to third contact holes 185a, 185b and 185c are positioned, so that discriminating the positions of the first transistor Qa, the second transistor Qb the third transistor Qc, and the first to third contact holes 185a, 185b and 185c may be simplified.

A lower alignment layer 11 is disposed on the light blocking member 330. The lower alignment layer 11 includes a reactive mesogen and provides the pretilt to the liquid crystal molecules 31 that are configured to be otherwise vertically aligned. A detailed description of the alignment layer 11 will be given later.

Next, the upper panel 200 will be described.

The common electrode 270 is disposed on an insulating substrate 210. An upper alignment layer 21 is disposed on the common electrode 270. The upper alignment layer 21 may be a vertical alignment layer. The upper alignment layer 21 includes the reactive mesogen and provides the pretilt to the liquid crystal molecules 31 that are configured to be otherwise vertically aligned. A detailed description of the alignment layer 21 will be given later.

The liquid crystal layer 3 has negative dielectric anisotropy, and the liquid crystal molecules 31 of the liquid crystal layer 3 are configured to be aligned so that long axes thereof are perpendicular to the surfaces of the two display panels 100 and 200 in a state in which there is no electric field.

Now, a basic electrode 199 will be described with reference to FIG. 3. As shown in FIG. 3, the overall shape of the basic electrode 199 is a quadrangle, and includes a cross-shaped stem including a transverse stem 193 and a longitudinal stem 192 that are crossed. Further, the basic electrode 199 is divided into a first subregion Da, a second subregion Db, a third subregion Dc and a fourth subregion Dd by the horizontal stem portion 193 and the vertical stem portion 192. The subregions Da to Dd respectively include a plurality of first fine branch portions 194a, a plurality of second fine branch portions 194b, a plurality of third fine branch portions 194c, and a plurality of fourth fine branch portions 194d.

The first fine branch portions 194a extend obliquely in an upper left direction from the horizontal stem portions 193 or the vertical stem portion 192, and the second fine branch portions 194b extend obliquely in an upper right direction from the horizontal stem portions 193 or the vertical stem portion 192. Further, the third fine branch portions 194c extend in a lower left direction from the horizontal stem portions 193 or the vertical stem portion 192, and the fourth fine branch portions 194d extend obliquely in a lower right direction from the horizontal stem portions 193 or the vertical stem portion 192.

The first to fourth fine branch portions 194a, 194b, 194c and 194d form an angle of approximately 45° or 135° with gate lines 121 or the transverse stem 193. Further, the fine branch portions 194a, 194b, 194c and 194d of two adjacent subregions Da, Db, Dc and Dd may be orthogonal to each other, but the invention is not limited thereto.

Widths of the fine branch portions 194a, 194b, 194c and 194d, taken perpendicular to an extension direction thereof, may be in the range of about 2.5 micrometers (μm) to about 5.0 μm. A gap or interval between adjacent fine branch portions 194a, 194b, 194c and 194d within a subregion Da, Db, Dc or Dd may be in the range of about 2.5 μm to about 5.0 μm.

According to another embodiment of the invention, the widths of the fine branch portions 194a, 194b, 194c and 194d may increase in a direction closer to the horizontal stem portion 193 or the vertical stem portion 192, and a difference between the widest width portion and the narrowest width portion within one of the fine branch portions 194a, 194b, 194c or 194d may be in the range of about 0.2 μm to about 1.5 μm.

The first subpixel electrode 191a and the second subpixel electrode 191b are connected to the first drain electrode 175a and the second drain electrode 175b through the first contact hole 185a and the second contact hole 185b, respectively, and receive the data voltage from the first drain electrode 175a and the second drain electrode 175b, respectively. Sides or edges of the first to fourth fine branch portions 194a, 194b, 194c and 194d distort an electric field and form a horizontal component thereof that determines an inclination direction of liquid crystal molecules 31. The horizontal component of the electric field is substantially horizontal to the sides of the first to fourth fine branch portions 194a, 194b, 194c and 194d. Accordingly, as illustrated in FIG. 3, the liquid crystal molecules 31 are inclined in a direction substantially parallel to a longitudinal direction (e.g., extension direction) of the fine branch portions 194a, 194b, 194c and 194d. Since a single basic electrode 199 includes the four subregions Da to Dd in which longitudinal directions of the fine branch portions 194a, 194b, 194c and 194d are different from each other, the directions in which the liquid crystal molecules 31 are inclined are about four directions, and four domains in which the alignment directions of the liquid crystal molecules 31 are different from each other are formed in the liquid crystal layer 3 with respect to the basic electrode 199. As described above, when the inclination direction of the liquid crystal molecules 31 is diversified, a reference viewing angle of the liquid crystal display is increased.

Next, the alignment layer of the liquid crystal display according to the invention will be described. In an exemplary embodiment of manufacturing the liquid crystal display, the alignment layer of the liquid crystal display is formed by coating and drying an aligning agent composition including two or more monomers, and an alignment solvent. The aligning agent composition may include the reactive mesogen.

The aligning agent composition forming an exemplary embodiment of the alignment layer of the liquid crystal display according to the invention will be described.

An exemplary embodiment of the aligning agent composition according to the invention includes two or more polyimide-based monomers, the reactive mesogen and the alignment solvent.

An exemplary embodiment of the aligning agent composition of the invention may include a first solvent improving solubility of the polymer as the alignment solvent, a second solvent improving spreadability, and a third solvent decreasing vapor pressure of the alignment solvent.

The first solvent may be N-methyl pyrrolidone (“NMP”). The NMP has a function of improving the solubility of the reactive monomer polymers. A content of NMP may be from about 45 weight percent to about 55 weight percent based on a total weight of the alignment solvent. In one exemplary embodiment, the content of NMP may be about 50 weight percent.

However, the first solvent is not limited to NMP. In exemplary embodiments, other materials in which the vapor pressure at 20 degrees Celsius (° C.) is from 0.25 millimeter of mercury (mm Hg) to about 0.35 mm Hg, and the surface tension at 25° C. is from about 35 dynes per centimeter (dyn/cm) to about 45 dyn/cm may be used.

The second solvent improves the spreadability when coating the aligning agent. The second solvent promotes uniform spreading of the aligning agent when coating the aligning agent, thereby improving uniformity of the thickness of the alignment layer formed using the aligning agent. The second solvent may be butyl carbitol (“BC”). The content of BC may be from about 30 weight percent to about 40 weight percent based on a total weight of the alignment solvent. In one exemplary embodiment, the content of BC may be about 35 weight percent.

However, the second solvent is not limited to BC. In exemplary embodiments, other materials in which the vapor pressure at 20° C. is from about 0.8 mm Hg to about 0.9 mm Hg and the surface tension at 25° C. is from about 20 dyn/cm to about 30 dyn/cm may be used.

The third solvent as a solvent having the relatively low vapor pressure has a function of increasing drying time of the aligning agent such that phase separation may be sufficiently performed during a drying process of the aligning agent. The third solvent may be propylene carbonate (“PC”). The content of PC may be from about 20 weight percent to about 40 weight percent based on a total weight of the alignment solvent. Also, the content of PC may be from about 4 weight percent to about 6 weight percent based on a total weight of the alignment solvent. PC has a function of reducing drying speed of the aligning agent such that the content of PC may be appropriately controlled according to the contents of the first solvent and the second solvent.

The third solvent is not limited to PC. In exemplary embodiment, other materials in which the vapor pressure at 20° C. is less than about 0.15 mm Hg and the surface tension at 25° C. is from about 35 dyn/cm to about 45 dyn/cm may be used.

In exemplary embodiments of the aligning agent composition according to the invention, a sum of the contents of the first solvent and the second solvent may be from about 70 weight percent to about 90 weight percent based on a total weight of the alignment solvent. A remaining portion of the alignment solvent may include the third solvent and/or an additive.

An exemplary embodiment of the aligning agent composition of the invention may additionally include a fourth solvent in the alignment solvent. The fourth solvent may control the vapor pressure as an additive. The fourth solvent may be 3-methoxy-N,N-dimethylpropionamide. The content of 3-methoxy-N,N-dimethylpropionamide may be from about 8 weight percent to about 12 weight percent based on a total weight of the alignment solvent.

Also, an exemplary embodiment of the aligning agent composition of the invention may include y-butyrolactone, diethylene glycol diethyl ether, or both as an additive in the alignment solvent.

The content of the additive of the aligning agent composition of the invention may be appropriately controlled according to the amount of the first solvent, the second solvent and the third solvent.

In an exemplary embodiment of the aligning agent composition according to the invention, the first solvent may be NMP, the second solvent may be BC, the third solvent may be PC, and the fourth solvent may be 3-methoxy-N,N-dimethylpropionamide, and based on a total weight of the alignment solvent, the content of N-methyl pyrrolidone may be from about 45 weight percent to about 55 weight percent, the content of BC may be from about 30 weight percent to about 40 weight percent, the content of PC may be from about 20 weight percent to about 40 weight percent, and the content of 3-methoxy-N,N-dimethylpropionamide may be from about 8 weight percent to about 12 weight percent.

In an exemplary embodiment of the aligning agent composition of the invention, the vapor pressure of the alignment solvent is from about 10 to about 20 mm Hg at 90° C., and the surface tension thereof is from about 38 dyn/cm to about 45 dyn/cm at 23° C. In an exemplary embodiment of the aligning agent composition of the invention, the vapor pressure of the alignment solvent is relatively low at about 80° C. to about 120° C. as a drying temperature of the aligning agent, and the surface tension is relatively high such that the drying slowly occurs in the drying process. Accordingly, the time for the phase separation of the polymer of two or more kinds included in the aligning agent composition is sufficiently generated, and a drying stain due to incomplete phase separation is not generated.

Next, an effect of the alignment layer manufactured from one or more exemplary embodiment of the aligning agent composition of the invention will be described with reference to a comparative example.

The aligning agent compositions of Exemplary Embodiments 1 to 3 and Comparative Example 1 including the alignment solvent having a composition detailed in Table 1 are provided. As described in Table 1, in the aligning agent compositions of Exemplary Embodiments 1 to 3, PC is included in the alignment solvent. However, in the aligning agent composition according to Comparative Example 1, PC is not included in the alignment solvent.

TABLE 1

| | | | | | | | | Surface |
|---|---|---|---|---|---|---|---|---|
| | Sam- | | | | Vapor Pressure | | | tension |
| | ple | Composition | | | (mm Hg) | | | (dyn/ |
| | name | NMP | BC | PC | 60° C. | 70° C. | 90° C. | cm) |
| Exemplary | A | 45 | 15 | 40 | 2.5 | 4.3 | 13 | 39.8 |
| Embodi- | | | | | | | | |
| ment 1 | | | | | | | | |
| Exemplary | B | 60 | 20 | 20 | 3.3 | 5.6 | 16.9 | 39.3 |
| Embodi- | | | | | | | | |
| ment 2 | | | | | | | | |
| Exemplary | C | 45 | 35 | 20 | 3.8 | 6.8 | 21.3 | 37 |
| Embodi- | | | | | | | | |
| ment 3 | | | | | | | | |
| Compar- | Ref | 45 | 55 | — | 5.2 | 9.3 | 30 | 34 |
| ative | | | | | | | | |
| Example 1 | | | | | | | | |

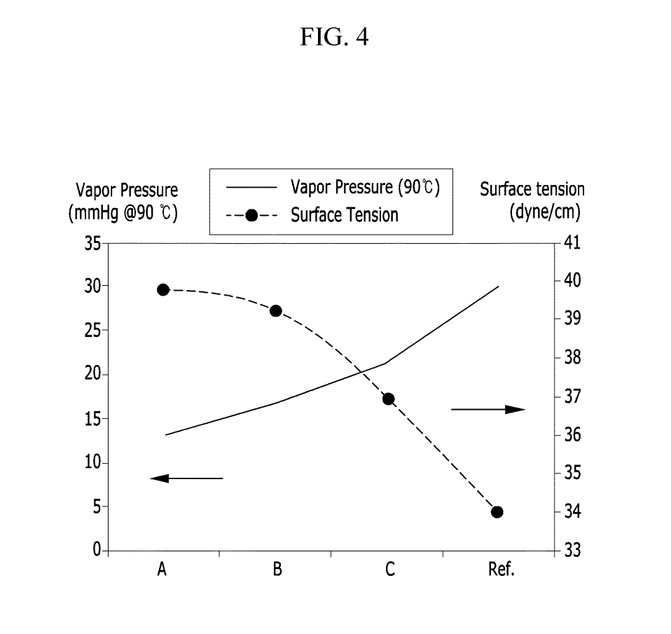

For each composition of the Exemplary Embodiments 1 to 3 and the Comparative Example 1, the vapor pressure is measured for each of a variety of temperatures and is shown in Table 1. Also, the surface tension measured at 23° C. is shown in Table 1. The measuring results are shown in FIG. 4.

Referring to Table 1 and FIG. 4, the vapor pressure of Exemplary Embodiments 1 to 3 including PC (A, B and C) is low compared with the Comparative Example 1 (Ref.), and the vapor pressure of Comparative Example 1 without PC is high compared with the Exemplary Embodiments 1 to 3. In contrast, the surface tension is high in Exemplary Embodiments 1 to 3 including PC compared with Comparative Example 1.

Referring to FIG. 4, in Exemplary Embodiment 1 (sample A) including the high content of PC, it may be confirmed that the vapor pressure is increased and the surface tension is decreased closer to Comparative Example 1 (sample Ref.) without PC.

That is, one or more exemplary embodiment of the aligning agent composition according to the invention includes the solvent (e.g., PC) having the low vapor pressure thereby decreasing the vapor pressure of the solvent and increasing the surface tension. As the material characteristics of one exemplary embodiment of the alignment solvent, the vapor pressure at 90° C. is from about 10 mm Hg to about 20 mm Hg, and the surface tension at 23° C. is from about 38 dyn/cm to about 45 dyn/cm. Accordingly, as well as PC provided in one or more exemplary embodiment of the invention, a material satisfying the conditions of the vapor pressure and the surface tension of the alignment solvent is not limited.

As described above, one or more exemplary embodiment of the aligning agent composition of the invention has the relatively low vapor pressure and the relatively high surface tension compared with the aligning agent composition according to the Comparative Example. Accordingly, in the step of drying the aligning agent after coating of a method of manufacturing a liquid crystal display, while the drying slowly occurs, the phase separation of the two or more polymers included in the aligning agent composition may be sufficiently generated. Accordingly, the drying stain due to the incomplete phase separation is not recognized.

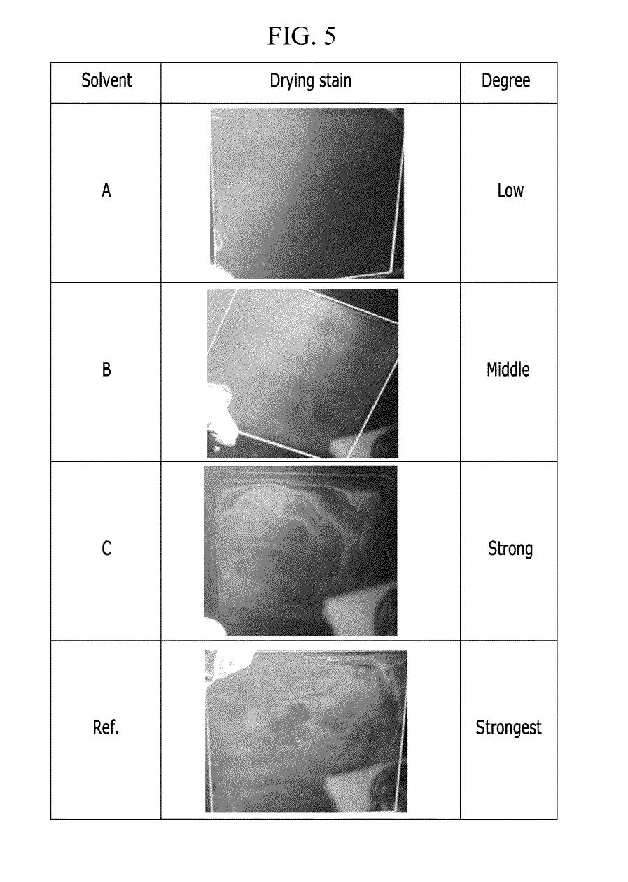

Next, effects of the aligning agent composition and the alignment layer manufactured from the aligning agent composition according to the invention will be described with reference to FIG. 5. FIG. 5 includes views of images of formed films after coating and drying an aligning agent composition according to Exemplary Embodiments of the invention and a Comparative Example, on a glass substrate.

Referring to FIG. 5, it may be confirmed that the strongest drying stain is generated in Comparative Example 1 (Ref.) without PC. This is the reason that the vapor pressure is high (at 90° C., 30 mm Hg) and the surface tension is low (at 23° C., 30 dyn/cm) in the Comparative Example 1 such that the drying quickly occurs. Accordingly, the phase separation of the polymer included in the aligning agent composition is not sufficiently generated, and a non-uniform surface arrangement of functional molecules of the reactive mesogen is generated. As shown in FIG. 5, a scattering stripe of Newton-ring shape appears, and an amorphous stain appears.

In contrast, one or more exemplary embodiment of the aligning agent composition of the invention is controlled to decrease the vapor pressure and increase the surface tension by adding PC. In detail, the vapor pressure of the aligning agent composition of Exemplary Embodiment 1 as the sample A is 13 mm Hg at 90° C., and the surface tension is 39.8 dyn/cm at 23° C. The vapor pressure of the aligning agent composition of Exemplary Embodiment 2 as the sample B is 16.9 mm Hg at 90° C., and the surface tension is 39.3 dyn/cm at 23° C. In detail, the vapor pressure of the aligning agent composition of Exemplary Embodiment 3 as the sample C is 21.3 mm Hg at 90° C., and the surface tension is 37 dyn/cm at 23° C.

Referring to FIG. 5, in the sample A in which the vapor pressure is lowest and the surface tension is highest, a degree of the drying stain is lowest. That is, the drying stain is hardly recognized in the sample A. Also, in the sample B and the sample C compared with the sample A, the drying stain partially exists, however, it may be confirmed that the drying stain is improved compared with the sample D as Comparative Example 1. That is, in one or more exemplary embodiment of the aligning agent composition according to the invention, the material (e.g., PC) having the relatively low vapor pressure is added to the solvent such that the vapor pressure and the surface tension of the aligning agent composition may be controlled to an optimized value such that the drying stain is not generated. In an exemplary embodiment, the vapor pressure at 90° C. is from about 10 to about 20 mm Hg, and the surface tension at 23° C. is from about 38 dyn/cm to about 45 dyn/cm.

One or more exemplary embodiment of the alignment layer of the liquid crystal display of the invention is manufactured by using the above-described aligning agent composition. Next, an exemplary embodiment of a method of manufacturing the alignment layer of the liquid crystal display of the invention will be described.

The aligning agent composition including the alignment material and the alignment solvent, is coated on two substrates 110 and 210.

After coating the aligning agent composition, the coated aligning agent composition is dried at a temperature from about 80° C. to about 120° C. This drying is otherwise referred to as a first drying or a pre-drying, and the coated aligning agent composition is dried while being flat. By such first or pre-drying, as well as the function of drying the aligning agent composition, the phase separation of the functional polymer (e.g., reactive mesogen) included in the aligning agent composition is generated, and the aligning agent composition is solidified into the alignment layer.

After the first drying, if necessary, a secondary drying may be performed. A temperature of the secondary drying may be similar to the temperature of the first drying.

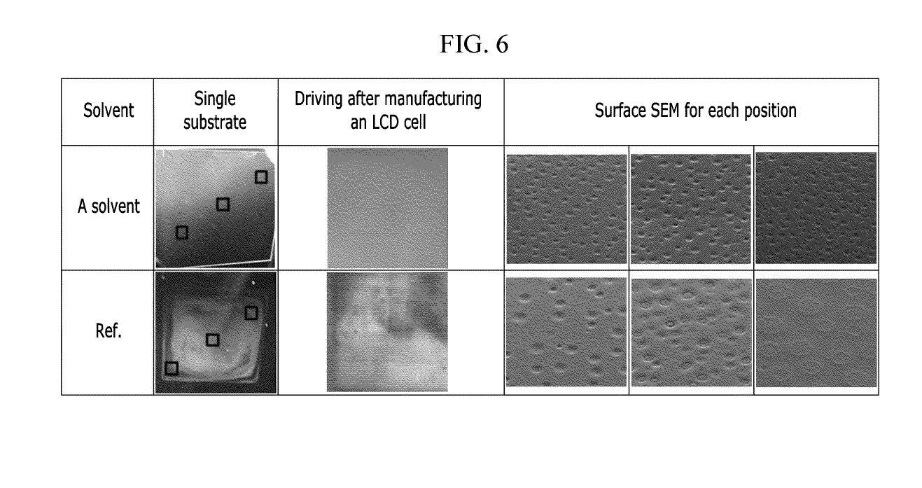

FIG. 6 includes views showing results of evaluating a surface via scanning electron microscope (“SEM”) for positions of a manufactured alignment layer of a liquid crystal display by using an aligning agent composition of Exemplary Embodiment 1 and Comparative Example 1.

Referring to FIG. 6, in Exemplary Embodiment 1 (A solvent) in which the vapor pressure and the surface tension of the aligning agent exist in the above-described ranges of the invention, the drying stain is not recognized in a single substrate, and the drying stain is not recognized when the liquid crystal display (“LCD”) cell is driven after the alignment layer is manufactured in the LCD.

However, in Comparative Example 1 (Ref.) in which the vapor pressure and the surface tension do not exist in the above-described ranges, the amorphous stain is recognized in a single substrate, and the stain is recognized after forming the alignment layer in the LCD and driving such LCD.

A rightmost column of views in FIG. 6 includes the surface SEM images for various positions of the alignment layer manufactured for each of the Exemplary Embodiment and the Comparative Example. The three views for the Exemplary Embodiment and the Comparative Example correspond to the portions indicated by a quadrangle in the ‘Single Substrate’ image column in FIG. 6.

Referring to FIG. 6, for the alignment layer formed of the aligning agent composition according to the Exemplary Embodiment of the invention, a size of the circles in the ‘Surface SEM for each position’ column appears to be substantially the same for each position indicated in the ‘Single Substrate’ column. That is, this circle represents the phase separation of the two or more functional polymers included in the aligning agent composition, and the size and the distribution of the circle for each position are similar. As a result, it may be confirmed that the phase separation is uniformly generated in the entire alignment layer according to the Exemplary Embodiment of the invention.

However, referring to FIG. 6, for the alignment layer formed of the aligning agent composition according to the Comparative Example, the size of the circles in the ‘Surface SEM for each position’ column appears different among positions indicated in the ‘Single Substrate’ column. That is, the size of the circles is relatively small in one region and the size of the circles is relatively large in another region. Also, the distribution of the circles is irregular. Accordingly, for the alignment layer formed of the aligning agent composition according to the Comparative Example, the phase separation is irregular in the entire alignment layer.

The phase separation is irregular in the entire alignment layer formed of the aligning agent composition according to the Comparative Example because the aligning agent composition according to the Comparative Example has the relatively high vapor pressure and the relatively low surface tension compared with the aligning agent composition according to the Exemplary Embodiment of the invention. Accordingly, in the Comparative Example, the coated aligning agent is quickly dried and the time in which the phase separation of the functional polymer is generated is not sufficient.

However, for the aligning agent composition according to the Exemplary Embodiment of the invention, the vapor pressure at 90° C. is from about 10 to about 20 mm Hg, and the surface tension of the aligning agent at 23° C. is from about 38 dyn/cm to about 45 dyn/cm. Accordingly, the vapor pressure is relatively low and the surface tension is relatively high compared with the Comparative Example. Therefore, the coated aligning agent is relatively slowly dried and the phase separation of the functional polymer is sufficiently generated during the drying, and the uniform phase separation is generated in the entire alignment layer. Accordingly, the alignment layer without the stain may be obtained.

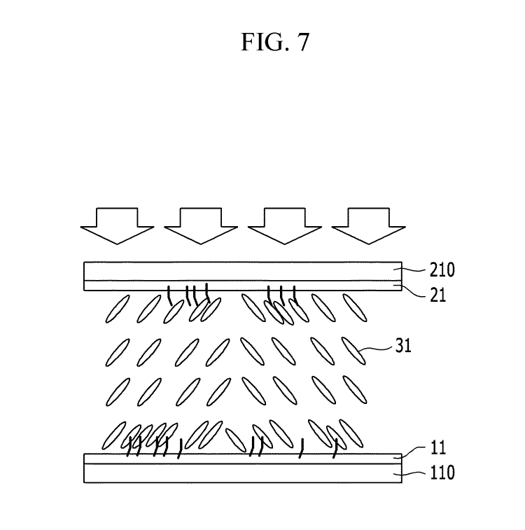

Next, a method of aligning the liquid crystal molecules to have the pretilt in the liquid crystal display of the invention will be described with reference to FIG. 7. FIG. 7 is a diagram illustrating an exemplary embodiment of a process of allowing liquid crystal molecules to have a pretilt by using an alignment layer including a light reaction group, such as with ultraviolet rays.

Firstly, as described above, the aligning agent including the aligning material is coated and dried on two substrates 110 and 210 to form the alignment layer. In an exemplary embodiment, the alignment material may include the alignment layer polymer, and the alignment layer polymer as a unit material may be formed by polymerizing a dianhydride compound and a diamine compound. The alignment layer polymer formed through the polymerization may include a polyimide or polyamic acid as one example

Referring to FIG. 1, FIG. 2 and FIG. 7, a data voltage is applied to a first subpixel electrode 191a and a second subpixel electrode 191b of a lower display panel 100, and a common voltage is applied to a common electrode 270 of an upper display panel 200, to generate an electric field in a liquid crystal layer 3 between the two display panels 100 and 200. The liquid crystal molecules 31 of the liquid crystal layer 3 may be tilted in directions parallel with length directions of fine branch portions 194a, 194b, 194c, and 194d (refer to FIG. 3) in response to the electric field. In an exemplary embodiment, directions in which the liquid crystal molecules 31 are tilted in one pixel may be a total of four directions.

While the electric field is generated in the liquid crystal layer 3, light such as ultraviolet rays is irradiated thereto, and a light reaction group included in the reactive mesogen reacts to form a cross-linking portion (not shown). The cross-linking portion (not shown) may have a pretilt. That is, the alignment layers 11 and 21 in which the linking of the light reaction group is completed have the pretilt by the previously described reactive mesogen, and if the voltage is applied to the field generating electrodes 191 and 270, the liquid crystal molecules 31 may be aligned while having the pretilt.

In the Comparative Example, when the functional molecules included in the alignment layer are non-uniformly disposed, the angle of the pretilt formed in the light irradiation and pretilt formation step is different for each region of a basic electrode. Accordingly, the stain is generated in the liquid crystal display by the non-uniformity of the pretilt angle.

However, in one or more exemplary embodiment of the invention, by forming the alignment layer by using the alignment solvent easily generating the phase separation when drying the alignment layer, the functional polymers are uniformly distributed in the alignment layer. Accordingly, the pretilt angle formed in the light irradiation and pretilt formation step is uniform without the difference for each region of the basic electrode, and the stain of the liquid crystal display due to the non-uniformity is not generated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a lower substrate;
an upper substrate facing the lower substrate;
an alignment layer on the lower substrate and the upper substrate; and
a liquid crystal layer between the lower substrate and the upper substrate,
wherein
the alignment layer comprises two monomers including polyimide and a reactive mesogen, and an alignment solvent,
the alignment solvent comprises a first solvent configured to increase solubility of a polymer, a second solvent configured to increase spreadability of the alignment solvent, and a third solvent configured to decrease vapor pressure of the alignment solvent,
a total content of the first solvent and the second solvent is from about 70 weight percent to about 95 weight percent based on a total weight of the alignment solvent, and
the alignment solvent has the vapor pressure at 90° C. from about 10 mm Hg to about 20 mm Hg.

2. The liquid crystal display of claim 1, wherein
surface tension of the alignment solvent at 23° C. is from about 38 dyn/cm to about 45 dyn/cm, and
the vapor pressure of the alignment solvent at 20° C. is from about 0.25 mm Hg to about 0.4 mm Hg.

3. The liquid crystal display of claim 2, wherein
the alignment solvent further comprises a fourth solvent as an additive.

4. The liquid crystal display of claim 3, wherein
the first solvent is N-methyl pyrrolidone,
the second solvent is butyl carbitol,
the third solvent is propylene carbonate, and
the fourth solvent is 3-methoxy-N,N-dimethylpropionamide.

5. The liquid crystal display of claim 4, wherein
based on the total weight of the alignment solvent,
the N-methyl pyrrolidone is from about 45 weight percent to about 55 weight percent,
the butyl carbitol is from about 30 weight percent to about 40 weight percent,
the propylene carbonate is from about 20 weight percent to about 40 weight percent, and
the 3-methoxy-N,N-dimethylpropionamide is from about 8 weight percent to about 12 weight percent.

6. The liquid crystal display of claim 4, wherein
the alignment solvent further comprises y-butyrolactone, diethylene glycol diethyl ether, or both y-butyrolactone and diethylene glycol diethyl ether.

7. The liquid crystal display of claim 5, wherein
a drying stain is absent in the alignment layer.

8. A method of manufacturing a liquid crystal display, comprising:
coating an aligning agent composition on a substrate; and
drying the coated aligning agent composition at a drying temperature from about 80° C. to about 120° C.,
wherein
the aligning agent composition comprises two monomers including polyimide and a reactive monomer, and an alignment solvent,
the alignment solvent comprises a first solvent configured to increase solubility of a polymer, a second solvent configured to increase spreadability of the alignment solvent, and a third solvent configured to decrease vapor pressure of the alignment solvent,
a total content of the first solvent and the second solvent is from about 70 weight percent to about 95 weight percent based on a total weight of the alignment solvent, and
the vapor pressure of the alignment solvent is from about 10 mm Hg to about 20 mm Hg at the drying temperature.

9. The method of claim 8, wherein
the alignment solvent further comprises a fourth solvent as an additive.

10. The method of claim 9, wherein
the first solvent is N-methyl pyrrolidone,
the second solvent is butyl carbitol,
the third solvent is propylene carbonate, and
the fourth solvent is 3-methoxy-N,N-dimethylpropionamide.

11. The method of claim 10, wherein
based on the total weight of the alignment solvent,
the N-methyl pyrrolidone is from about 45 weight percent to about 55 weight percent,
the butyl carbitol is from about 30 weight percent to about 40 weight percent,
the propylene carbonate is from about 20 weight percent to about 40 weight percent, and
the 3-methoxy-N,N-dimethylpropionamide is from about 8 weight percent to about 12 weight percent.

12. The method of claim 11, wherein
the drying the aligning agent composition generates a uniform phase separation of the two monomers.

13. The method of claim 11, wherein
the drying the aligning agent composition does not generate a stain in the dried alignment layer.

14. An aligning agent composition comprising:
two monomers comprising polyimide and a reactive monomer, and
an alignment solvent,
wherein
the alignment solvent comprises a first solvent configured to increase solubility of a polymer, a second solvent configured to increase spreadability of the alignment solvent, and a third solvent configured to decrease vapor pressure of the alignment solvent,
a total content of the first solvent and the second solvent is from about 70 weight percent to about 95 weight percent based on a total weight of the alignment solvent, and
the alignment solvent has the vapor pressure at 90° C. from about 10 mm Hg to about 20 mm Hg.

15. The aligning agent composition of claim 14, wherein
surface tension of the alignment solvent at 23° C. is from about 38 dyn/cm to about 45 dyn/cm, and
the vapor pressure at 20° C. is from about 0.25 mm Hg to about 0.4 mm Hg.

16. The aligning agent composition of claim 15, wherein
the alignment solvent further comprises a fourth solvent as an additive.

17. The aligning agent composition of claim 16, wherein
the first solvent is N-methyl pyrrolidone,
the second solvent is butyl carbitol,
the third solvent is propylene carbonate, and
the fourth solvent is 3-methoxy-N,N-dimethylpropionamide.

18. The aligning agent composition of claim 17, wherein
based on the total weight of the alignment solvent,
the N-methyl pyrrolidone is from about 45 weight percent to about 55 weight percent,
the butyl carbitol is from about 30 weight percent to about 40 weight percent,
the propylene carbonate is from about 20 weight percent to about 40 weight percent, and
the 3-methoxy-N,N-dimethylpropionamide is from about 8 weight percent to about 12 weight percent.

19. The aligning agent composition of claim 18, wherein
the alignment solvent further comprises y-butyrolactone, diethylene glycol diethyl ether, or both y-butyrolactone and diethylene glycol diethyl ether.
